(19) United States
(12) Patent Application Publication
(10) Pub. No.: US 2026/0194482 A1
(43) Pub. Date: Jul. 9, 2026

(54) MEASURING METHOD FOR SENSORS BASED ON POLYMER NANOCOMPOSITES AND SENSOR BASED ON POLYMER NANOCOMPOSITES

(71) Applicant: NANOSEN GMBH, Chemnitz (DE)

(72) Inventors: Rajarajan RAMALINGAME, Chemnitz (DE); Olfa KANOUN, Chemnitz (DE)

(21) Appl. No.: 19/426,493

(22) Filed: Dec. 19, 2025

Related U.S. Application Data
(63) Continuation of application No. PCT/DE2024/100568, filed on Jun. 26, 2024.

(30) Foreign Application Priority Data
Jun. 29, 2023 (DE) 102023117192.5

(51) Int. Cl. G01N 27/02

(52) U.S. Cl. CPC G01N 27/026

(57) ABSTRACT

A measuring method for sensors based on polymer nanocomposites including selection of 3+ different frequencies, and subsequently measuring the impedances of the sensor at those different frequencies. Next, the impedances are analyzed to determine an impedance model. Finally, the parameter-identification module identifies an optimal measuring parameter based on the impedance model. The optimal measuring parameter has the highest degree of sensitivity and selectivity for excitation of the sensor. The optimal measuring parameter is used for real-time monitoring of the sensor response at one or more of the at least three different frequencies. Also disclosed is a nanocomposite sensor including electrically conductive nanoparticles in a polymer matrix. The nanoparticles are smaller than 130 nm in at least one dimension, and an electrode structure is in contact with the polymer nanocomposite sensor layer, wherein electrical signals generated by the sensor in response to applied stimuli are measured in the electrode structure.

### RELATED APPLICATIONS

This application is a continuation of international application PCT/DE2024/100568 filed on Jun. 26, 2024 that claims priority from German patent application DE 10 2023 117 192.5, filed on Jun. 29, 2023, both of which are incorporated in their entirety by this reference.

### FIELD OF THE INVENTION

The invention relates to a measuring method for sensors based on polymer nanocomposites and a sensor based on polymer.

### BACKGROUND OF THE INVENTION

In the field of electrochemistry, the evaluation and performance analysis of various systems are based on the use of an equivalent impedance model. This model is usually achieved by applying electrochemical impedance spectroscopy (EIS), which is widely used in the investigation of sensors for medical applications, gas sensors, and electrochemical systems such as batteries, fuel cells, corrosion processes, and electrode/electrolyte interfaces.

Conventionally, EIS is measured over a wide frequency range, typically ranging from a few millihertz to a few megahertz. Based on the resulting Nyquist diagram, an equivalent impedance model is developed to represent the system under investigation. Using curve fitting, the data obtained from the model is then compared with the measured data. This allows an assessment of how well the model agrees with the experimental results, wherein the behavior and characteristics of the system can be evaluated. In certain cases, individual parameters of the model are also analyzed to illustrate their influence on the measuring parameters.

This contributes to a deeper understanding of the system response and the role of the individual parameters.

In the field of electrical impedance spectroscopy, which extends beyond the field of electrochemistry, the focus is on analyzing the electrical properties of various systems, which include resistive, capacitive, and inductive components in particular. This technique provides insights into the electrical behavior, material properties, and response of the system under investigation.

Impedance spectroscopy is sometimes used for the electrical characterization of sensors based on polymer nanocomposites, which can be used to measure physical stimuli such as force, pressure, strain, temperature, and humidity. These sensors are characterized over a wide frequency range, ranging from a few hertz to several megahertz. The literature reports on the use of impedance spectroscopy in two ways. On the one hand, as a characterization tool for validating measured data against simulated data using an equivalent circuit model, or as a measuring method in which the entire impedance spectrum represents the excitation of the sensor.

The classic approach to impedance spectroscopy, in which a wide frequency range is scanned, is time-consuming. The measuring process can take several seconds to minutes, making it impractical for real-time monitoring of sensor response. The reason for this is frequency sampling, since impedance spectroscopy requires sampling over a wide frequency range. This method involves taking impedance measurements at numerous points, which requires a considerable amount of time and resources. The large frequency range contributes to the overall duration of the measuring process. This limitation makes it difficult to detect dynamic changes in the behavior of the sensor.

In addition, the complexity of implementing impedance spectroscopy in an embedded system is a major disadvantage. The hardware and software requirements for accurate impedance measurement at multiple frequencies can be very extensive. This complexity of development, integration, and maintenance increases the cost and technical requirements associated with integrating such a system into practical applications.

Another disadvantage is the limitation of single-frequency measurements. Measuring at a specific frequency only can compromise the sensitivity and selectivity of the sensor. Different sensor parameters may have different frequency responses, and important information may be lost when analyzing sensor performance at a single frequency. A single-frequency measurement cannot fully capture the behavior of the sensor.

This can lead to inaccurate characterization and suboptimal performance, in particular incomplete characterization and impaired sensitivity and selectivity of the sensor.

Furthermore, the lack of real-time capability hinders application in dynamic environments where immediate and continuous monitoring of sensor response is required. The inability to capture dynamic changes and fluctuations in sensor behavior limits effectiveness in certain applications.

The publication EP 3 242 128 A1 describes a method for monitoring a composite material, wherein the composite material consists of an epoxy resin filled with electrically conductive nanoparticles, wherein at least one electrical property, such as the impedance of the composite material, is influenced by mechanical deformation.

The composite material is integrated into an electrical circuit which transmits an electrical signal, the value of which depends on the electrical property of the composite material, so that a warning message is issued when a certain threshold value is exceeded. The measured property of the sensor is, in particular, the electrical impedance. A disadvantage is the multiple measurements in a range from 1 mV to 220 V. This requires many measurements and therefore limits the possibility of real-time monitoring.

The publication DE 100 18 745 A1 describes a method and device for the rapid measurement of complex electrical resistances or impedance spectra, wherein the electrical properties of lipid membranes are recorded using the method and device, and the method enables the measurement and characterization of non-stationary systems with high time resolution. This is a method for measuring impedance in the conventional manner for use in characterizing lipid-protein membranes in the laboratory and for detecting adsorption processes. The method is not suitable as a measuring method for field sensors outside the laboratory.

The publication EP 2 902 774 B1 describes the continuous or nearly continuous monitoring and evaluation of the properties, in particular the carbonate hardness, of liquids and non-solid materials, wherein this field of application differs from the present invention. The measuring method proposes the use of a specific impedance equivalent circuit containing a CPE element in series with a parallel connection of a resistor and a capacitor. Furthermore, the parameters for measuring the properties of aqueous solutions are specified in this patent. The parameters for the equivalent circuits are selected not according to their sensitivity but according to their physical significance.

It is the object of the invention to develop a measuring method for sensors based on polymer nanocomposites and a sensor based on polymer nanocomposites, which provides a simple design and a reliable, fast measuring method for time savings and real-time capability. Furthermore, a suitable sensor for carrying out the method is to be provided, which can be operated not only under laboratory conditions.

### BRIEF SUMMARY OF THE INVENTION

The invention relates to a measuring method for sensors based on polymer nanocomposites, wherein the method comprises a measuring device connected to the sensor, an analysis module, a parameter-identification module, and a monitoring module, wherein, in a first step of the method, a selection of at least three different frequencies within a specified frequency range is made, and subsequently the impedance of the sensor excited at the selected frequencies is measured in the selected frequency range by means of the measuring device. However, more frequencies within the frequency range are also possible.

In a second method step, the measured impedance values are analyzed in order to determine an impedance model of the sensor by means of the analysis module. Subsequently, in a third step of the method, the parameter-identification module identifies the optimal measuring parameter based on the impedance model, wherein the optimal measuring parameter has the highest degree of sensitivity and selectivity for excitation of the sensor. In the fourth step, an optimal measuring parameter is used by the monitoring module for real-time monitoring of the sensor response at one or more of the selected frequencies.

Advantageously, the impedance measurement comprises the following steps:
a.) a time/frequency-varying current or voltage signal that is processed using the discrete Fourier transform (DFT) to derive frequency-dependent components,
b.) processing the frequency-dependent components to calculate the frequency-dependent impedance spectrum Z(f), and
c.) analyzing the impedance spectrum Z(f) using a signal processing unit to obtain the measuring parameters of the sensor.

The sensor output is recorded and analyzed in such a way that the sensor to be tested is first subjected to a current or voltage signal that varies in time and frequency without any external excitation signals, and the corresponding voltage or current pulse is measured. These signals are then separated using signal analysis techniques such as discrete Fourier transform (DFT) to extract the corresponding frequency-dependent voltage U(f) and current I(f), which form the basis for calculating Z(f), or to extract the frequency-dependent gain and phase directly. The frequency range typically used ranges from 1 Hz to 100 MHz. It can be extended depending on the sensor effect and sensor dimensions. This analysis provides insights into the complex electrical behavior of polymer nanocomposite sensors.

The impedance spectrum obtained is then processed by a signal processing unit. This could advantageously be based, for example, on an equivalent circuit model (ECM), a neural network (NN), a calculation of the distributed relaxation times (DRT), a calculation of the differential impedance analysis (DIA), or a combination of these and other signal processing methods of impedance spectroscopy, e.g., digital filters. Each of these methods can provide various key indicators, such as various electrical parameters from ECM, various features and machine learning models from NN, distribution of time constants from DRT, and local equivalent circuit model from DIA.

These key indicators are then used to track and measure the desired measuring parameters of the sensor.

In an advantageous design of the method, the three or more selected frequencies are evenly distributed within the frequency range.

The impedance model preferably comprises a series resistance (Rₛ), a parallel resistance (Rₚ), and a parallel capacitance (Cₚ).

In one design of the method, the impedance model may comprise a constant phase element (a) as a substitute for the parallel capacitance (Cₚ) in the case of a depressed semicircular Nyquist plot.

The optimal measuring parameter is preferably determined by evaluating the sensitivity and selectivity of each parameter in the impedance model.

In an advantageous design of the method, real-time monitoring of the sensor response at the selected frequencies is performed using an embedded circuit.

The admittance and/or the permittivity and/or the dielectric constant and/or the capacitance of the sensor are preferably measured on the basis of polymer nanocomposites in the specified frequency range.

The sensor according to the invention based on polymer nanocomposites has a polymer nanocomposite sensor layer, wherein the nanocomposite sensor layer comprises electrically conductive nanoparticles embedded in a polymer matrix, wherein the nanoparticles are smaller than 130 nm in at least one dimension. An electrode structure is in contact with the polymer nanocomposite sensor layer, wherein electrical signals generated by the sensor in response to applied stimuli can be measured by means of the electrode structure. It is particularly preferred that the nanoparticles have a diameter of less than 100 nm in at least one dimension. These nanoparticles are responsible for providing the desired electrical conductivity. They can be metallic, carbon-based, or a combination of both.

The polymer matrix of the polymer nanocomposite sensor layer belongs to one or more of the following polymer groups, in particular to thermosetting, thermoplastic, cross-linked, elastomeric, biodegradable, and/or conductive polymers. The selection of the polymer matrix depends on the specific requirements and desired performance of the sensor.

The electrode structure is configured in one design in the form of a parallel plate electrode structure, in which the sensor layer is arranged between two electrode plates.

Alternatively, the electrode structure may be designed as an interdigital electrode structure, in which the sensor layer is attached or deposited on the electrode to establish electrical contact.

The two main types of electrode structures mentioned above are commonly used in sensor designs. The first type, the parallel plate electrode structure, is designed such that the sensor layer is arranged between two electrode plates. This configuration ensures that the electric field is evenly distributed across the sensor layer. The second type is the interdigitated electrode structure, in which the electrodes are arranged in an interdigitated pattern. In this configuration, the sensor layer is applied or deposited onto the electrodes to establish electrical contact. Various techniques are used to manufacture these electrode structures, depending on the desired substrate and the requirements of the sensor.

The nanocomposite material of the sensor can be synthesized using techniques such as solution mixing, melt mixing, in-situ polymerization, electrospinning, layer-by-layer deposition, and inclusion polymerization.

In an advantageous design, the nanocomposite sensor is manufactured using techniques such as spin coating, dip coating, spray coating, layer-by-layer deposition, filament winding, drop casting, mold casting, electrospinning, laser reduction, hold pressing, 3D printing, screen printing, and inkjet printing.

The electrodes of the electrode structure are preferably manufactured using techniques such as physical vapor deposition, chemical vapor deposition, screen printing, photolithography, inkjet printing, electroplating, or laser ablation.

The choice of coating technique depends on factors such as the desired sensor design, substrate compatibility, and manufacturing requirements.

The proposed invention offers several advantages over the prior art and, in particular, over the conventional approach to impedance measurement in sensors based on polymer nanocomposites. On the one hand, the conventional approach, in which impedance spectroscopy is performed over a wide frequency range, is time-consuming. Data acquisition typically takes several seconds to minutes and is therefore impractical for real-time monitoring of sensor responses. In contrast, the method according to the invention uses a minimum of three selected frequencies in particular. This results in faster measurement times without compromising accuracy.

Furthermore, the classic approach requires complex embedded systems to perform impedance spectroscopy measurements. This complexity limits the practical implementation of the measuring method, especially in applications that require real-time monitoring. The solution according to the invention shortens the measuring process and allows the use of less complex embedded circuits without compromising the performance of the sensor.

In addition, the applied multi-frequency measurement offers additional advantages. By simultaneously measuring the impedance at multiple frequencies, it is possible to determine the optimal measuring parameter that exhibits the highest sensitivity and selectivity to the excitations of the sensor. This measuring parameter is crucial for the accurate characterization and monitoring of the sensor response.

The sensor according to the invention is particularly suitable for carrying out the method according to the invention. The sensor is used in particular for measuring force, temperature, strain, and humidity.

### BRIEF DESCRIPTION OF THE DRAWINGS

The invention is explained in more detail below based on an advantageous embodiment with reference to drawing figures, wherein:

FIG. 1 shows a polymer nanocomposite sensor layer 1 between a parallel plate electrode structure 2;

FIG. 2 shows an alternative design of the sensor in the form of a polymer nanocomposite sensor layer 1 in combination with an interdigitated electrode structure 3;

FIG. 3 shows the measurement sequence that provides the various parameters of the sensor. For this purpose, a calculation is performed in a computing unit 4 and the result is forwarded to a signal processing unit 5. The key indicators 6 are determined by means of the signal processing unit 5;

FIG. 4 shows a plot illustrating the correlation between the various components of the impedance and the excitation signal;

FIG. 5 shows how some or all of these parameters are fed to a signal processing unit 5, which provides the measuring parameters 7;

FIG. 6 shows a typical Nyquist diagram of the polymer nanocomposite-based sensor, wherein the curves represent a variant with parallel capacitance and a variant with constant phase element;

FIG. 7 shows a typical equivalent circuit diagram for the variant with parallel capacitance and constant phase element;

FIG. 8 shows a representation of a typical real impedance curve plotted against the logarithm of the frequency, wherein at least three frequencies are selected that are equidistant in different frequency decades;

FIG. 9 shows a diagram illustrating the correlation between the various parameters of the equivalent circuit and the measured quantity;

FIG. 10 shows the Bode diagram of the real and imaginary components of the impedance as a function of frequency from 100 Hz to 1 MHz for different applied weights;

FIG. 11 shows the Bode diagram of the real and imaginary components of the impedance as a function of frequency from 100 Hz to 1 MHz for different applied weights;

FIG. 12 shows data plotted as a Nyquist curve plotted;

FIG. 13 shows various functional modules of the embedded system;

FIG. 14 shows data plotted for another Nyquist diagram;

FIG. 15 shows the identification of the measuring parameters;

FIG. 16 and FIG. 17 show graphs collectively show that the real part of the impedance is relatively more sensitive to the applied weights than the imaginary part;

FIG. 18 show another graph that show the real part of the impedance is less affected by changes in the applied weights;

FIG. 19 show another graph that show the imaginary part shows good sensitivity;

FIG. 20 shows a graph that shows the real part remains virtually unaffected by changes in the applied weight;

FIG. 21 shows a graph that shows the imaginary part exhibits relatively linear sensitivity to the applied weight;

FIG. 22 shows a graph of the imaginary part at 500 Hz;

FIG. 23 shows a graph of the imaginary part at 5 kHz; and

FIG. 24 shows a graph of the imaginary part at 50 KHz.

### DETAILED DESCRIPTION OF THE INVENTION

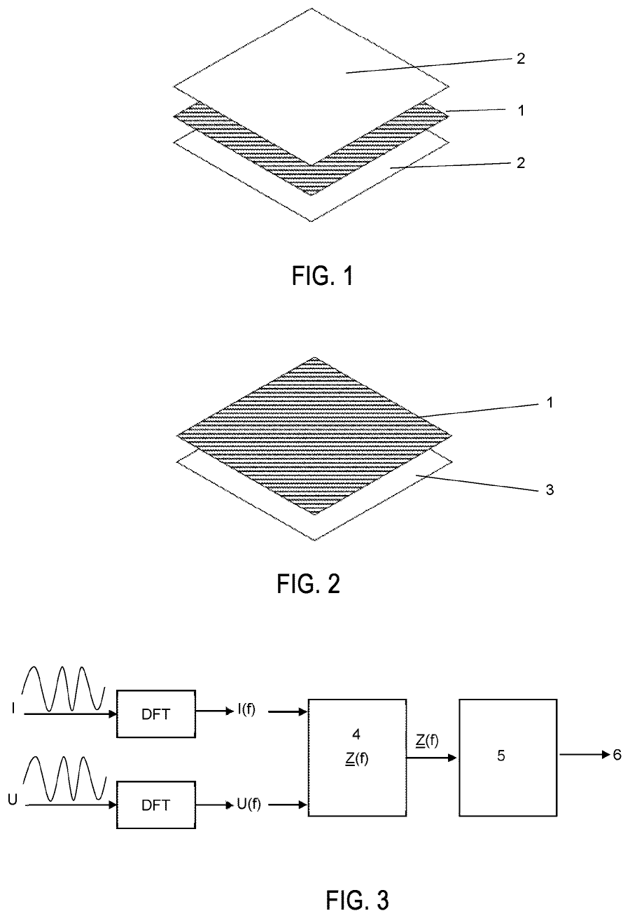

FIG. 1 shows a polymer nanocomposite sensor layer 1 between a parallel plate electrode structure 2.

FIG. 2 shows an alternative design of the sensor in the form of a polymer nanocomposite sensor layer 1 in combination with an interdigitated electrode structure 3.

FIG. 3 shows the measurement sequence that provides the various parameters of the sensor. For this purpose, a calculation is performed in a computing unit 4 and the result is forwarded to a signal processing unit 5. The key indicators 6 are determined by means of the signal processing unit 5.

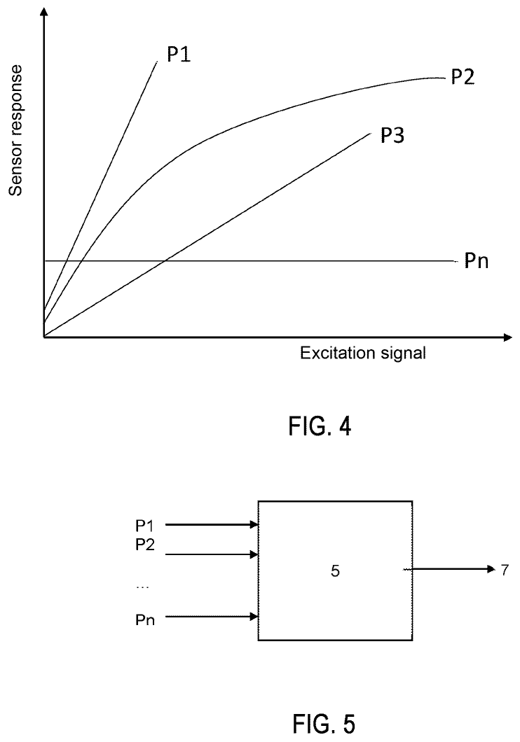

FIG. 4 shows a plot illustrating the correlation between the various components of the impedance and the excitation signal.

FIG. 5 shows how some or all of these parameters are fed to a signal processing unit 5, which provides the measuring parameters 7.

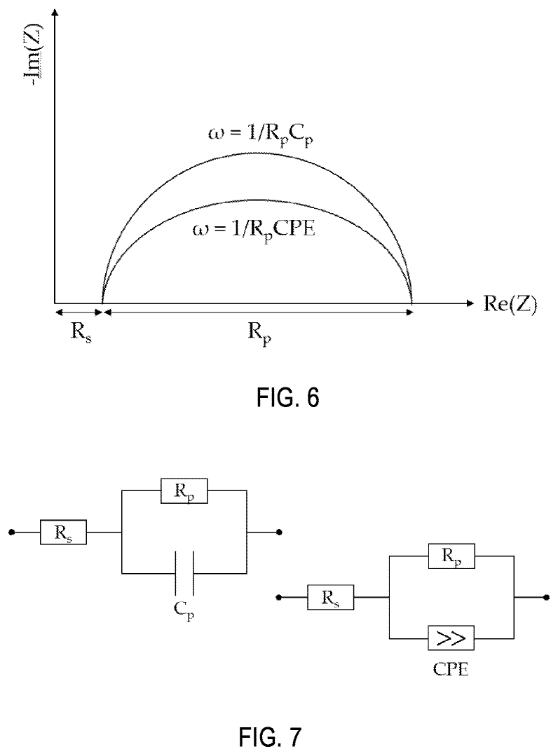

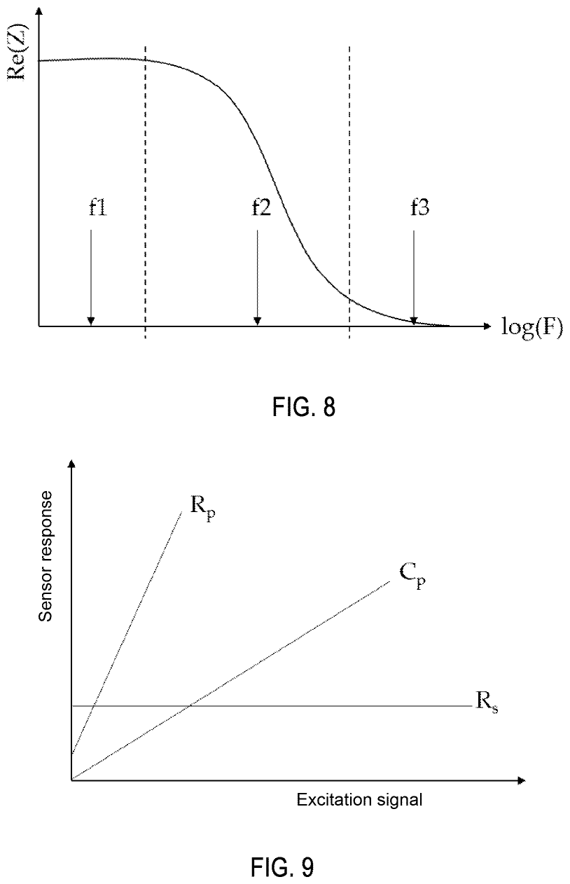

FIGS. 6 to 9 illustrate an example of the use of ECM as a signal processing unit. More specifically, FIG. 6 shows a typical Nyquist diagram of the polymer nanocomposite-based sensor, wherein the curves represent a variant with parallel capacitance and a variant with constant phase element. FIG. 7 shows a typical equivalent circuit diagram for the variant with parallel capacitance and constant phase element. FIG. 8 shows a representation of a typical real impedance curve plotted against the logarithm of the frequency, wherein at least three frequencies are selected that are equidistant in different frequency decades. FIG. 9 shows a diagram illustrating the correlation between the various parameters of the equivalent circuit and the measured quantity.

The frequency-dependent impedance of the sensor is determined and a Nyquist diagram is created (FIG. 6) that shows the complex impedance of the sensor.

The Nyquist plot shows three parameters of interest: series resistance (Rₛ), parallel resistance (Rₚ), parallel capacitance (Cₚ). In certain cases, the Nyquist plot may have a depressed semicircular shape, indicating the presence of a constant phase element (CPE) instead of Cₚ. Through careful analysis of the Nyquist diagram and extraction of the relevant parameters, a comprehensive ECM can be constructed (FIG. 7) to represent the electrical response of the polymer nanocomposite-based sensor.

To ensure a comprehensive analysis of the polymer nanocomposite-based sensor, at least three frequencies are selected for the three measuring parameters (as shown in FIG. 8). These measuring parameters (see FIG. 9) are then used to measure the response of the sensor at one or more of the selected frequencies. This method significantly improves both the sensitivity and selectivity of the sensor for a specific measuring parameter. This amplification enables a more precise and accurate measurement of the sensor's response to the desired excitation signals. As a result, the overall performance of the sensor and its ability to detect and distinguish specific excitation signals in real time is significantly improved.

In addition, the measuring method can be performed with various impedance-related quantities. These include complex admittance (G*=1/Z*), dielectric modulus (M*=jωZ*) and capacitance (K*=1/M*). To increase the effectiveness of the method, two or more frequencies can be selected. By incorporating multiple frequencies, a more robust and accurate model can be achieved, resulting in improved accuracy, sensitivity, and selectivity of the sensor.

In addition to sensitivity and selectivity, the method enables the analysis and monitoring of various other properties of the sensor. These properties include linearity, aging characteristics, homogeneity, and many more. By applying the same method, a comprehensive understanding of the performance and behavior of the sensor can be achieved, enabling a thorough evaluation and optimization of its overall functionality.

The invention provides an optimized measuring method for sensors based on polymer nanocomposites, which focuses on simultaneous impedance measurements at multiple frequencies within a specified frequency range, wherein the frequencies are tuned to the excitation of the sensor. According to the method, a comprehensive set of impedance values is measured, representing various properties of the polymer nanocomposite.

By analyzing the measured impedances, various parameters are derived within an impedance model that accurately represent the behavior of the polymer nanocomposite sensor. Each parameter is assigned to a specific feature or property of the sensor. Taking into account the relationship between the parameters and the desired sensor performance, the parameter that has the greatest influence on achieving the desired result can be identified.

This determined parameter, known as the optimal measuring parameter, is then used as a key factor for sensor operation and performance optimization. By monitoring the optimal sensor parameter, the disadvantages of conventional measuring methods are greatly minimized and the overall performance of sensors based on polymer nanocomposites is maximized.

An example of impedance spectroscopic analysis of a sensor based on polymer nanocomposites is described below.

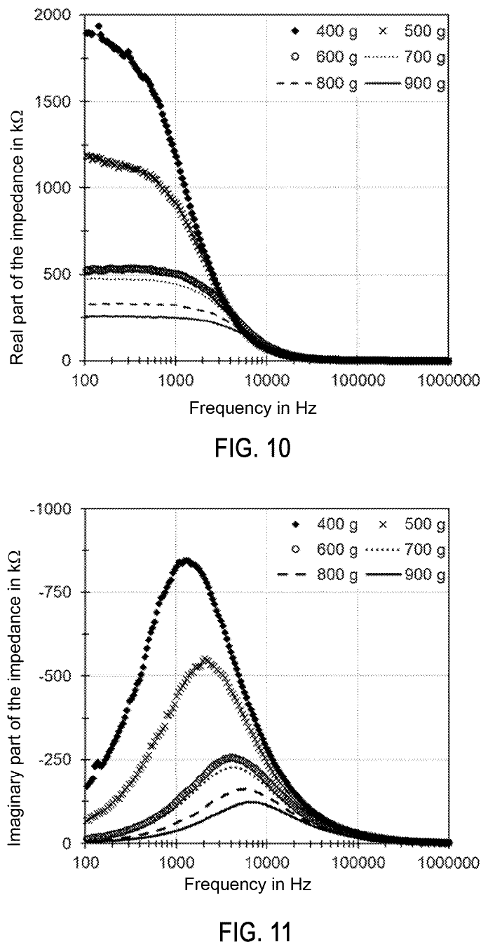

The exemplary sensor is a sensor based on a polymer nanocomposite material in combination with a contact electrode structure. In this example, the sensor functions as a force sensor whose electrical properties change when an external force acts on the sensor. The sensor is connected to an impedance measurement device to examine its electrical properties. Examples of such devices include impedance analyzers, LCR meters, network analyzers, electrochemical impedance spectroscopy devices, frequency response analyzers, oscilloscopes with impedance functions, digital multimeters with impedance functions, and embedded systems based on integrated chips for impedance measurements with integrated microcontrollers or microprocessors. The device is configured to measure the impedance of the sensor over a frequency range from 1 Hz to 100 MHz. Both the real (resistance) and imaginary (reactance) components of the impedance are recorded. These measurements correspond to the response of the sensor to various weights applied to the sensor at. FIGS. 10 and 11 show the Bode diagrams of the real and imaginary components of the impedance as a function of frequency from 100 Hz to 1 MHz for different applied weights.

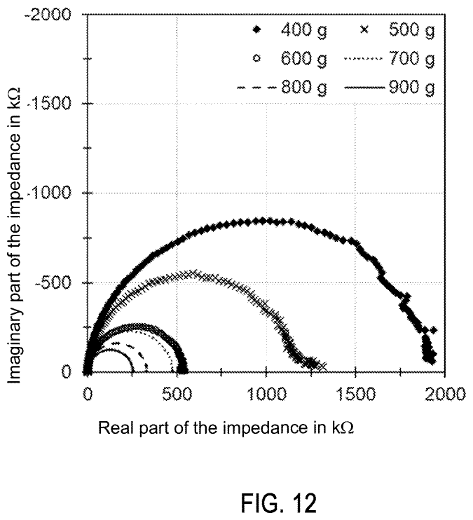

The data is then recorded as a Nyquist curve, as shown in FIG. 12, which plots the real part of the impedance against the imaginary part of the impedance. This representation is particularly useful for visualizing the complex impedance behavior of the sensor. By analyzing the Nyquist curve, characteristic semicircular patterns and other shapes that reflect the electrical properties of the sensor can be identified. Based on the Nyquist curve and the Bode diagram, three or more different frequencies can be selected. In this example, the first frequency (500 Hz) is selected between 100 Hz and 1 kHz, the second frequency (5 kHz) between 1 KHz and 10 KHz, and the third frequency (50 kHz) between 10 kHz and 100 KHz.

An exemplary measuring device based on an embedded solution is shown below.

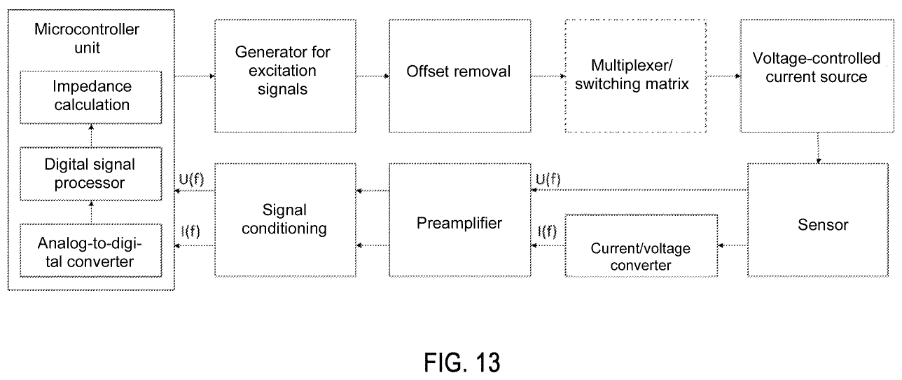

Taking the selected frequencies into account, a portable solution for measurement using the sensor is developed. The portable solution can be based on c-DAQ, FPGA, or a microcontroller. Compared to other solutions, a microcontroller-based solution is inexpensive, compact, and energy-efficient. The various functional modules of the embedded system are shown in FIG. 13 and include a signal processing unit, an offset removal module, an optional multiplexer or matrix switching module, voltage-controlled current sources (VCCS), the measurement object, the measurement system, the preamplifier, the signal conditioning, and a microcontroller unit containing the analog-to-digital converter (ADC), the digital signal processor (DSP), and the impedance calculator.

The signal processing unit is used to synthesize the excitation signal with the selected frequency, which is implemented by the integrated pulse width modulation (PWM) or digital-to-analog converter (DAC) or by external chips such as direct digital synthesis chips (DDS) or arbitrary waveform generators (AWG). Since most signal generation units can only supply positive voltages, an offset voltage (DC bias) is always present. In order to perform impedance measurement without DC bias, the offset voltage must be removed from the DDS, DAC, and PWM devices, which can be achieved using a subtractor or a high-pass filter. The optional multiplexer/switching matrix module is required when more than one DUT or a DUT is used as an array or matrix. The VCCS is essential for maintaining a constant current in a circuit by regulating the current to match an input voltage, regardless of the impedance of the sensor. Several VCCS architectures can be used, including load-in-the-loop, Howland circuits and derivatives, Tietze circuits, current conveyor (CCII), and operational transconductance amplifier (OTA), with Howland circuits being particularly suitable for high-frequency measurements.

This excitation signal is transmitted to the sensor, which is connected to a measurement system. The measurement system is based on the I-U method, bridge mode, resonance method, or self-balancing bridge.

I-V method: Based on the simultaneous measurement of voltage and current, which are subjected to AC analysis to extract the amplitude and phases of the current and voltage signals and thus the impedance.
Bridge system: Based on the balance of two impedance arms, one of which contains the reference impedance and the other the object under test. When balanced, the reference impedance and the sensor have the same voltage, so no current flows between the arms.
Resonance method: This method involves feeding a sinusoidal signal into the system and measuring the response to determine the impedance. The impedance can be calculated by analyzing the frequency at which the maximum response occurs.
Auto-balancing bridge: Uses a reference signal that is automatically shifted in phase to emulate the impedance response. When the signal is symmetrical, it emulates the reference object under test and the system is balanced.

Both the I-U method and the auto-balancing bridge have very good measurement accuracy and can measure frequencies up to 1 MHz. In a measurement system based on the I-U method, the excitation signal generator injects a voltage (potentiostatic mode) or a current (galvanostatic mode) into the sensor. A preamplifier module is used when signal amplification is required for better detection. The signal conditioning module usually consists of active filters, differential operational amplifiers, instrumentation amplifiers, and amplifiers. Signal conditioning ensures that the microcontroller can read and interpret the signal by reducing noise and amplifying the signal to match the voltage levels of the microcontroller (e.g., 0 to 3.3 V).

For accurate impedance measurement, it is important to measure both the response of the system and the excitation signal applied. Synchronization of the timers responsible for excitation and voltage and current measurements is critical. Based on the current and voltage signals in the time domain, an AC analysis is performed to determine the amplitude ratio and phase shift between the voltage and current signals.

This can be done with analog circuits or with digital signal processing. In analog circuits such as I/Q demodulation or the gain phase detector (GPD), analog multiplication circuits demodulate the amplitude and phase of the response signal, followed by a low-pass filter. The real and imaginary values are output as DC voltages using the I/Q demodulator, while the gain and phase are output as DC voltages using the GPD. In digital signal processing, the voltage and current signals are processed and then connected directly to an ADC. The microcontroller extracts the magnitude and phase after a digital AC analysis.

The extracted amplitudes and phases of the voltage and current signals are then analyzed using DFT (discrete Fourier transform) solutions, wherein methods such as fast Fourier transform (FFT) and the Goertzel filter are employed to accelerate the calculation of the DFT coefficients. Other methods such as the discrete-time Fourier transform (DTFT), sine fitting using ordinary least squares (OLS) and nonlinear least squares (NLLS) can also be used. Microcontrollers, such as those based on ARM technology like STM32, use special libraries (e.g., CMSIS) for efficient signal processing that support operations such as FFT for signal lengths up to 4096 and improve computing power and memory management in impedance analysis applications.

The impedance is determined after calculating the real and imaginary parts of the voltage and current signals using AC analysis methods at excited frequencies. For an excited frequency index (f), this is done by a complex division of the voltage U(f) by the current I(f) as follows:

$$Z ( f ) = \frac{V ( f )}{I ( f )}$$

The equivalent circuit model corresponding to the sensor can be used to decompose the measured impedance of the sensor and calculate the various components of the impedance. The microcontroller-based solution can also be connected to ICs that have been specially developed for impedance measurement and represent a compact and energy-efficient solution. Examples of these impedance measurement ICs are AFE4300, MAX32600, AD5933, and AduCM350.

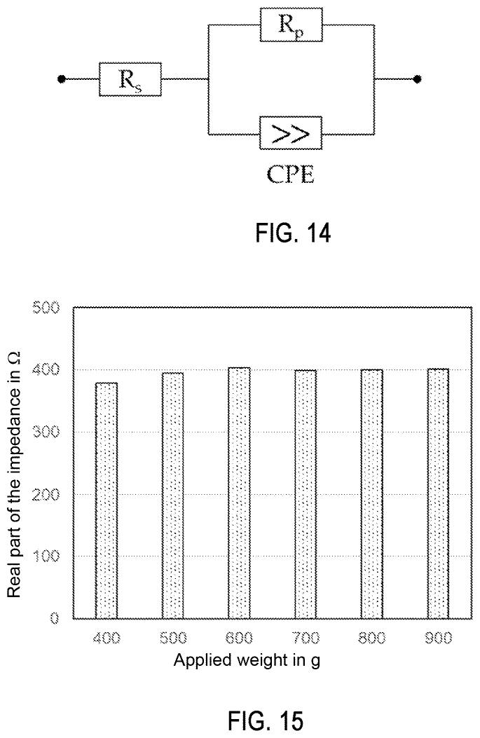

The sensor is then excited with the three selected frequencies, and the impedance change is determined for the various applied weights. The information obtained is then entered into the equivalent circuit model to calculate the various components of the impedance. Understanding the equivalent circuit model is essential for predicting sensor behavior under various conditions and for optimizing the design for improved sensitivity. In this example, the Nyquist diagram in FIG. 14 shows that it is not characterized by a perfect semicircle, indicating the presence of a constant phase element (CPE). The resulting equivalent circuit represents the impedance characteristics of the sensor through a combination of electrical components such as series resistance (Rₛ), parallel resistance (Rₚ), and parallel capacitance or a constant phase element (CPE), as shown in FIG. 13, and is expressed as:

$${Z}_{OUT} = {R}_{s} + \frac{1}{CPE} + \frac{1}{{R}_{p}}$$

Wherein Rₛ is the resistance between the contact electrode and the sensor material and the intrinsic resistance of the conductive nanoparticles in the sensor material, Rₚ is the tunnel resistance between the nanoparticles in the polymer matrix, CPE is the frequency-dependent impedance caused by inhomogeneities or distributed time constants.

The CPE, which is represented as:

$$CPE = {Q ( j ω )}^{α}$$

Wherein
Q is a constant,
ω is the angular frequency,
α is a parameter ranging from 0 to 1,
and for α=1, CPE behaves like an ideal capacitor.

FIG. 15 shows the identification of the measuring parameters, with the Rₛ value being significantly smaller than that of the other components. A detailed representation of the Rₛ value shows that Rₛ is not greatly affected by changes in the applied weight, suggesting that a high-frequency component is not suitable for this sensor.

However, both Rₚ and CPE vary significantly with the applied weight at frequencies between 100 Hz and 1 MHz. One or more frequencies at different intervals within the frequency range can be selected to understand the influence of the frequencies on the various electrical parameters. For example, three frequencies are considered:

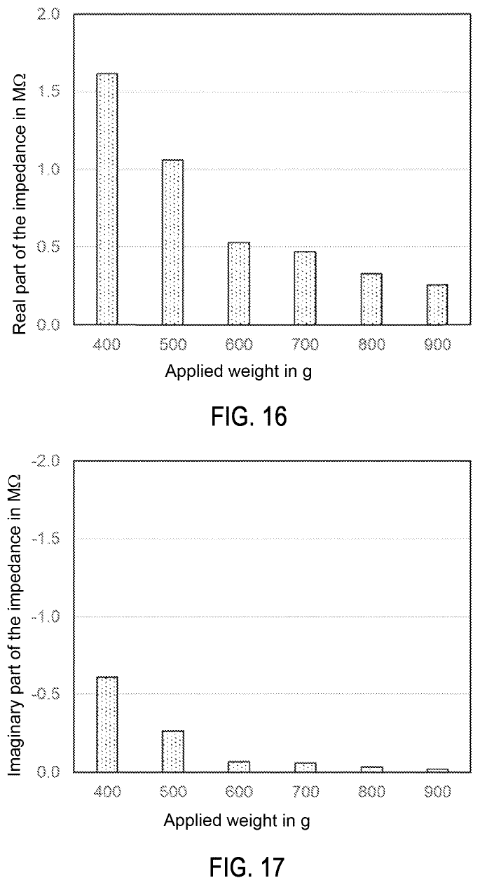

1. First frequency (500 Hz): Selected between 100 Hz and 1 kHz. At this frequency, FIGS. 16 and 17 show that the real part of the impedance is relatively more sensitive to the applied weights than the imaginary part.

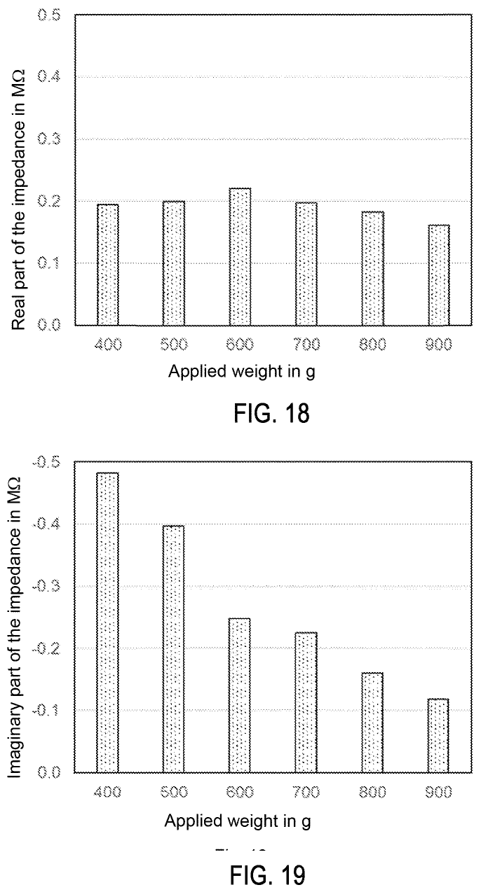

2. Second frequency (5 kHz): Selected between 1 kHz and 10 KHz. At this frequency, FIGS. 18 and 19 show that the real part of the impedance is less affected by changes in the applied weights; however, the imaginary part shows good sensitivity.

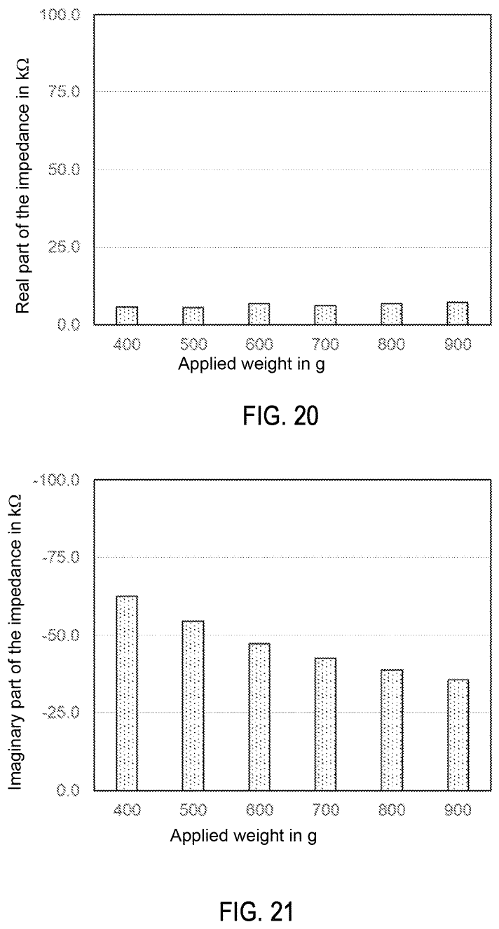

3. Third frequency (50 kHz): Selected between 10 KHz and 100 kHz. At this frequency, FIGS. 20 and 21 show that the real part remains virtually unaffected by changes in the applied weight, while the imaginary part exhibits relatively linear sensitivity to the applied weight.

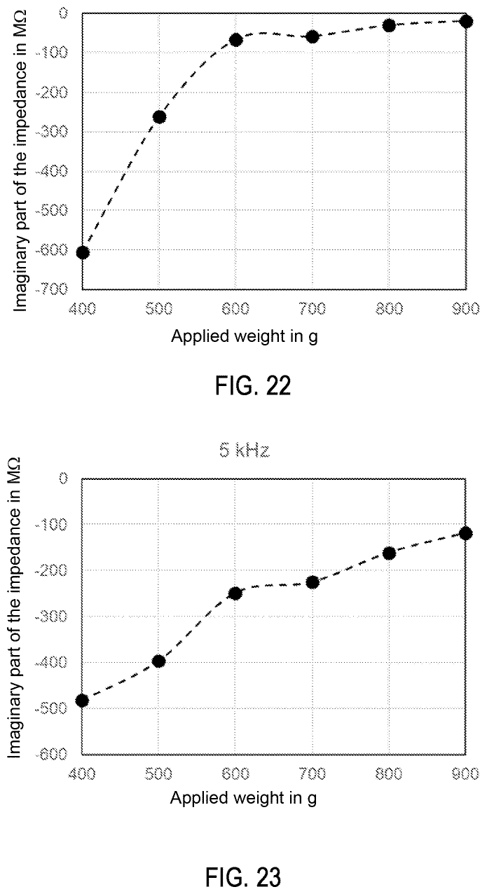

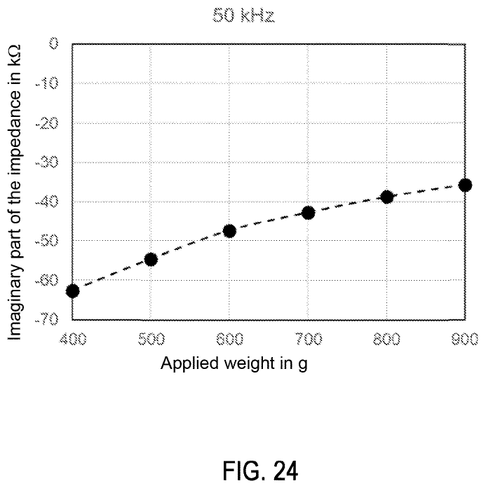

Comparing the sensitivity to the parameters within these three frequencies from FIG. 22, FIG. 23, and FIG. 24, the third frequency (50 kHz) shows good sensitivity and better linearity for the imaginary part of the impedance, i.e., the CPE, with negligible influence from the real part, i.e., Rₛ and Rₚ. Thus, the CPE is the optimal measuring parameter for this sensor.

With regard to real-time monitoring of the sensor, the measuring device is programmed to measure the optimal measuring parameter of the sensor, in particular the CPE, at a frequency of 50 KHz. To increase stability, additional frequencies close to this selected frequency can be used to measure the sensor. Averaging the CPE of the impedance over these frequencies enables stable real-time monitoring of the sensor response.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

### REFERENCE NUMERALS AND DESIGNATIONS

1. Polymer nanocomposite sensor layer
2. Plate electrode structure
3. Electrode structure
4. Computing unit
5. Signal processing unit
6. Key indicators
7. Measuring parameters

What is claimed is:

1. A measuring method for sensors based on polymer nanocomposites that includes a measuring device connected to a sensor, an analysis module, a parameter-identification module, and a monitoring module, wherein the method comprises:
in a first method step, a selection of at least three different frequencies within a specified frequency range is made, and subsequently impedances of the sensor excited the at the at least three different frequencies is measured in the specified frequency range by the measuring device, and
in a second method step, the impedances are analyzed to determine an impedance model of the sensor by the analysis module,
in a third method step, the parameter-identification module identifies an optimal measuring parameter based on the impedance model, wherein the optimal measuring parameter has the highest degree of sensitivity and selectivity for excitation of the sensor, and
the optimal measuring parameter is used by the monitoring module for real-time monitoring of the sensor response at one or more of the at least three different frequencies.

2. The method according to claim 1, characterized in that the impedance measurement comprises the following steps:
processing a time/frequency-varying current or voltage signal using a discrete Fourier transform (DFT) to derive frequency-dependent components,
processing the frequency-dependent components to calculate the frequency-dependent impedance spectrum Z(f), and
analyzing the impedance spectrum Z(f) using a signal processing unit to obtain measuring parameters of the sensor.

3. The method according to claim 2, wherein the signal processing unit comprises an equivalent circuit model for extracting various electrical parameters and/or a neural network for extracting various features and applying machine learning models or an analysis of the distributed relaxation times for determining the distribution of the time constants or a differential impedance analysis for deriving a local equivalent circuit model.

4. The method according to claim 1, wherein the three or more selected frequencies are evenly distributed within the frequency range.

5. The method according claim 1, wherein the impedance model comprises a series resistance (Rₛ), a parallel resistance (Rₚ), and a parallel capacitance (Cₚ).

6. The method according claim 1, wherein the impedance model comprises a constant phase element (a) as a substitute for the parallel capacitance (Cₚ) in the case of a depressed semicircular Nyquist plot.

7. The method according claim 1, wherein the optimal measuring parameter is determined by evaluating the sensitivity and selectivity of each parameter in the impedance model.

8. The method according claim 1, wherein real-time monitoring of the sensor response at the selected frequencies is performed using an embedded circuit.

9. The method according claim 1, wherein the admittance and/or the permittivity and/or the dielectric constant and/or the capacitance of the sensor based on polymer nanocomposites is measured in the specified frequency range.

10. A nanocomposite sensor based on polymer nanocomposites for performing a measuring method according to claim 1 with a polymer nanocomposite sensor layer, characterized in that the nanocomposite sensor layer comprises electrically conductive nanoparticles embedded in a polymer matrix, wherein the nanoparticles are smaller than 130 nm in at least one dimension, and in that an electrode structure is in contact with the polymer nanocomposite sensor layer, wherein electrical signals generated by the sensor in response to applied stimuli can be measured by the electrode structure.

11. The nanocomposite sensor according to claim 10, wherein the polymer matrix of the polymer nanocomposite sensor layer belongs to one or more of the following polymer groups: thermosetting, thermoplastic, cross-linked, elastomeric, biodegradable, and conductive polymers.

12. The nanocomposite sensor according to claim 10, wherein the electrode structure has a parallel plate electrode structure in which the sensor layer is arranged between two electrode plates.

13. The nanocomposite sensor according to claim 11, wherein the electrode structure has a parallel plate electrode structure in which the sensor layer is arranged between two electrode plates.

14. The nanocomposite sensor according to claim 10, wherein the electrode structure has a parallel plate electrode structure in which the sensor layer is arranged between two electrode plates.

15. The nanocomposite sensor according to claim 11, wherein the electrode structure has a parallel plate electrode structure in which the sensor layer is arranged between two electrode plates.

16. The nanocomposite sensor according to claim 10, wherein the electrode structure has an interdigital electrode structure in which the sensor layer is attached or deposited on the electrode to establish electrical contact.

17. The nanocomposite sensor according to claim 11, wherein the electrode structure has an interdigital electrode structure in which the sensor layer is attached or deposited on the electrode to establish electrical contact.

18. The nanocomposite sensor according to claim 10, wherein the nanocomposite material is synthesized by one of solution mixing, melt mixing, in situ polymerization, electrospinning, layer-by-layer deposition, and inclusion polymerization.

19. The nanocomposite sensor according to claim 10, wherein the nanocomposite sensor is manufactured using one of spin coating, dip coating, spray coating, layer-by-layer deposition, filament winding, drop casting, mold casting, electrospinning, laser reduction, hold pressing, 3D printing, screen printing, and inkjet printing.

20. The nanocomposite sensor according to claim 10, wherein the electrode structure includes electrodes are manufactured by one of physical vapor deposition, chemical vapor deposition, screen printing, photolithography, inkjet printing, electroplating, or laser ablation.
